(19) United States
(12) Patent Application Publication
(10) Pub. No.: US 2017/0222943 A1
(43) Pub. Date: Aug. 3, 2017

(54) METHOD AND APPARATUS FOR REORDERING

(71) Applicant: MEDIATEK INC., Hsin-Chu City (TW)

(72) Inventors: YU-TING YAO, Tainan City (TW); Chih-Heng Shih, Taichung City (TW); Yu-Cheng Chen, Jhubei City (TW); Shen-Po Lin, Taichung City (TW); Kuo-Chiang Liao, Hsinchu City (TW); Chia-Ning Chang, Nantou City (TW)

(73) Assignee: MEDIATEK INC., Hsin-Chu City (TW)

(21) Appl. No.: 15/414,368

(22) Filed: Jan. 24, 2017

Related U.S. Application Data
(60) Provisional application No. 62/288,486, filed on Jan. 29, 2016.
(60) Provisional application No. 62/372,338, filed on Aug. 9, 2016.

(51) Int. Cl. H04L 12/863; H04L 29/12; H04L 29/06

(52) U.S. Cl. CPC H04L 47/624; H04L 69/16; H04L 65/1083; H04L 61/1511

(57) ABSTRACT

Aspects of the disclosure provide a method for reordering. The method includes receiving, by a terminal device, a stream of data units from a wireless network. The data units have respective sequence numbers. Further, the method includes reordering at a protocol layer in a protocol stack, the data units for a next process according to the sequence numbers, determining a dependency relationship of a data unit to one or more missing data units that have sequence numbers prior to the data unit, and advancing, out of order of the sequence numbers, the data unit to the next process when the data unit is independent of the one or more missing data units.

### INCORPORATION BY REFERENCE

This present disclosure claims the benefit of U.S. Provisional Application No. 62/288,486, “PDCP Reordering Enhancement for TCP Sessions” filed on Jan. 29, 2016, and U.S. Provisional Application No. 62/372,338, “WiFi RX Reorder Buffer Enhancement” filed on Aug. 9, 2016, which are incorporated herein by reference in their entirety.

### BACKGROUND

The background description provided herein is for the purpose of generally presenting the context of the disclosure. Work of the presently named inventors, to the extent the work is described in this background session, as well as aspects of the description that may not otherwise qualify as prior art at the time of filing, are neither expressly nor impliedly admitted as prior art against the present disclosure.

In wireless communication, reorder operation is performed for in-sequence delivery. In a Universal Mobile Telecommunications System (UMTS) or long-term evolution (LTE) technology example, user equipment can receive out-of-order data units for example due to a handover and reestablishment. According to the UMTS or LTE technology, the user equipment uses a protocol stack having multiple protocol layers to process the data units. One of the protocol layers, such as a packet data convergence protocol (PDCP) layer, reorders the data units to be in-sequence according to sequence numbers, and then sends the in-sequence data units to an upper protocol layer.

### SUMMARY

Aspects of the disclosure provide a method for reordering. The method includes receiving, by a terminal device, a stream of data units from a wireless network. The data units have respective sequence numbers. Further, the method includes reordering at a protocol layer in a protocol stack, the data units for a next process according to the sequence numbers, determining a dependency relationship of a data unit to one or more missing data units that have sequence numbers prior to the data unit, and advancing, out of order of the sequence numbers, the data unit to the next process when the data unit is independent of the one or more missing data units.

To determine the dependency relationship of the data unit to the one or more missing data units that have the sequence numbers prior to the data unit, in an embodiment, the method includes determining, at a packet data convergence protocol (PDCP) layer in a protocol stack (e.g., a long term evolution (LTE) protocol stack, universal mobile telecommunications system (UMTS) protocol stack, etc.), the dependency relationship of the data unit to the one or more missing data units that have the sequence numbers prior to the data unit. In an example, the sequence numbers are PDCP sequence numbers in the PDCP layer, the method includes extracting, at the PDCP layer, a transmission control protocol (TCP) sequence number for a TCP session in the data unit, and determining whether the TCP sequence number is in sequence in the TCP session. Further, the method includes advancing, out of order of the PDCP sequence numbers, the data unit to the next process when the TCP sequence number is in sequence in the TCP session.

In another embodiment, to determine the dependency relationship of the data unit to the one or more missing data units that have the sequence numbers prior to the data unit, the method includes determining, at a data link layer in a Wi-Fi protocol stack, the dependency relationship of the data unit to the one or more missing data units that have the sequence numbers prior to the data unit.

In an example, the method includes determining that the data unit is an independent data unit when the data unit belongs to at least one of an address resolution protocol (ARP), an internet control message protocol (ICMP), a domain name system (DNS) protocol. In another example, the method includes determining that the data unit is independent of the one or more missing data units when the data unit belongs to a packet flow that uses a higher level protocol to control an in-sequence delivery. For example, the method includes determining that the data unit is independent of the one or more missing data units when body of the data unit belong to one of a transmission control protocol (TCP), user datagram protocol (UDP), and dynamic host configuration protocol (DHCP) that use additional higher level information, such as session sequence numbers, position information, a combination of multiple fields of higher level protocol, and the like to control the in-sequence delivery.

Aspects of the disclosure provide an apparatus that includes a receiver circuit and a processing circuit. The receiver circuit is configured to receive a wireless signal from a wireless network and generate a stream of data units in response to the wireless signal. The data units have respective sequence numbers. The processing circuit is configured to reorder, at a protocol layer in a protocol stack, the data units for a next process according to the sequence numbers, determine, a dependency relationship of a data unit to one or more missing data units that have sequence numbers prior to the data unit and advance, out of order of the sequence numbers, the data unit to the next process when the data unit is independent of the one or more missing data units.

Aspects of the disclosure provide another apparatus that includes a receiver circuit, a memory and one or more processors. The receiver circuit is configured to receive a wireless signal from a wireless network and generate a stream of data units in response to the wireless signal. The data units have respective sequence numbers. The memory is configured to store program instructions of a protocol stack for data unit processing. The one or more processors are configured to execute the program instructions to reorder, at a protocol layer in the protocol stack, the data units for a next process according to the sequence numbers, determine, a dependency relationship of a data unit to one or more missing data units that have sequence numbers prior to the data unit, and advance, out of order of the sequence numbers, the data unit to the next process when the data unit is independent of the one or more missing data units.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a communication system 100 according to an embodiment of the disclosure;

FIG. 2 shows a diagram of data unit reordering and delivery in a Wi-Fi protocol stack according to an embodiment of the disclosure;

FIG. 3 shows a flow chart outlining a process 300 for data unit reordering and delivery according to an embodiment of the disclosure;

FIG. 4 shows another diagram of data unit reordering and delivery in a long-term evolution (LTE) protocol stack according to an embodiment of the disclosure; and

FIG. 5 shows another flow chart outlining a process 500 for data unit reordering and delivery according to an embodiment of the disclosure.

### DETAILED DESCRIPTION OF EMBODIMENTS

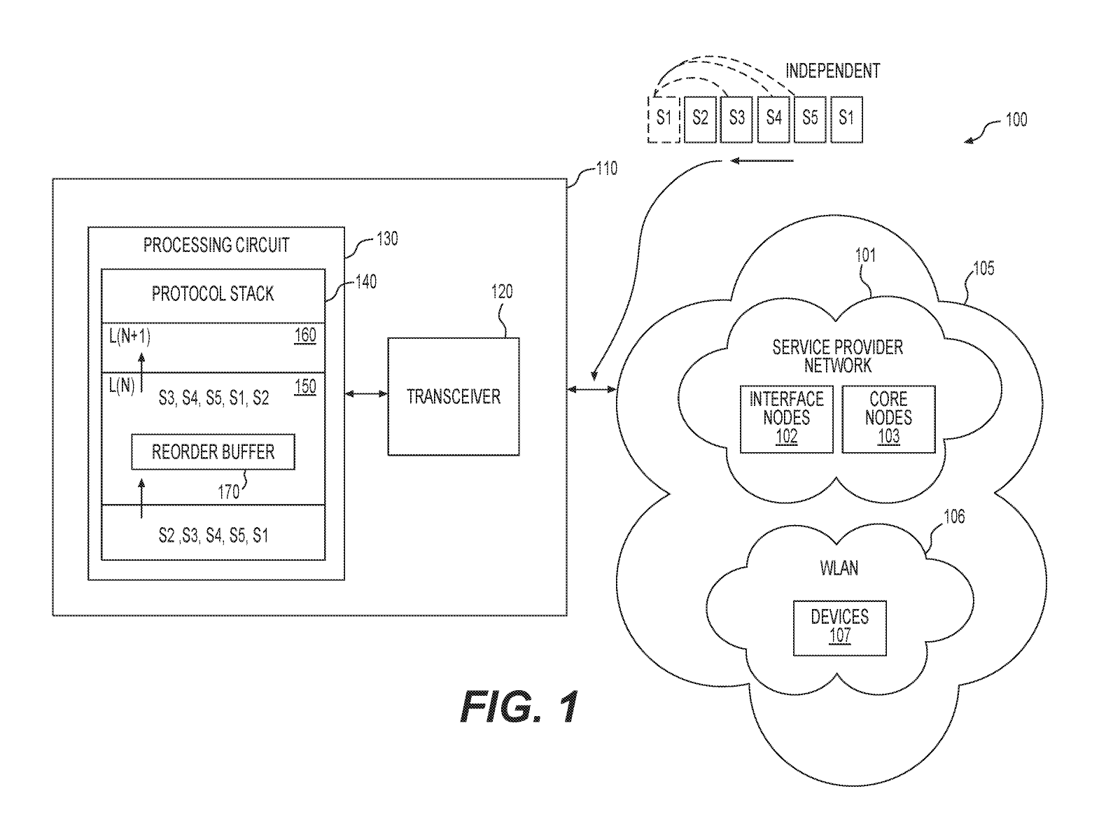

FIG. 1 shows a diagram of a communication system 100 according to an embodiment of the disclosure. The communication system 100 may include an electronic device 110 that receives wireless communication service from a network 105. The electronic device 110 may receive a plurality of data units from the network 105. The plurality of data units can be received out of order of sequence numbers. The electronic device 110 may include a protocol stack having multiple protocol layers to process the plurality of data units. The protocol stack may include a specific protocol layer to reorder the data units, and provide reordered data units to a next process, such as an upper protocol layer. The specific protocol layer may be configured to advance, out of order of the sequence numbers, a data unit to the next process when the data unit is independent of one or more missing data units having sequence numbers that are prior to the data unit.

The network 105 can include any suitable wireless communication service provider network, such as a mobile service provider network, a Wi-Fi service provider network, and the like. In an embodiment, the network 105 includes a mobile service provider network 101 that can be implemented using any suitable mobile communication technology, such as third generation (3G) mobile network technology, fourth generation (4G) mobile network technology, fifth generation (5G) mobile network technology, global system for mobile communication (GSM), long-term evolution (LTE), Universal Mobile Telecommunications System (UMTS) and the like. The mobile service provider network 101 may include a plurality of nodes, such as interface nodes 102, core nodes 103, and the like that are coupled together by any suitable network technology, such as wired, wireless, fiber optical network, and the like.

In an example, the interface nodes 102, such as base transceiver stations, Node Bs, evolved Node Bs, and the like, include hardware components and software components configured to enable wireless communications between the interface nodes and electronic devices, such as the electronic device 110, and the like that has subscribed services provided by the mobile service provider network 101. Further, in the example, the core nodes 103 include hardware components and software components to form a backbone to manage and control the services provided by the mobile service provider network 101.

In another embodiment, the network 105 includes a wireless local area network (WLAN) 106 that can be implemented using any suitable wireless standard, such as various IEEE 802.11 standards. For example, the WLAN 106 can include a plurality of WLAN devices 107, switches (not shown), a management server (not shown) and the like coupled together. The WLAN devices can be access points (APs), stations (STAs), etc. In an example, the WLAN devices 107 include hardware components and software components configured to enable wireless communications between the WLAN devices 107 and electronic devices, such as the electronic device 110, and the like that have joined the WLAN 106.

It is noted that the network 105 can include other suitable components (not shown) that are implemented using any suitable network technology, such wired, wireless, a cellular communication technology, a local area network (LAN), a WLAN, a fiber optical network, a wide area network (WAN), a peer-to-peer network, the Internet, and the like.

The electronic device 110 can be any suitable electronic device that performs wireless communication with the network 105. In an example, the electronic device 110 is a terminal device (user equipment) used by an end-user for mobile telecommunication, such as a cell phone, a smart phone, a tablet computer, an Internet of Things (IoT) device and the like. The electronic device 110 may include a transceiver circuit 120 and a processing circuit 130 coupled together as shown in FIG. 1. In other examples, the transceiver circuit 120 can be replaced with separate transmitter and receiver.

The transceiver circuit 120 is configured to receive and transmit wireless signals. In an example, the transceiver circuit 120 may include a transmitting circuit (not shown) and a receiving circuit (not shown) coupled to an antenna (not shown). The transmitting circuit can be a transmitter and the receiving circuit can be a receiver. The receiving circuit may be configured to generate electrical signals in response to captured electromagnetic waves by the antenna, process the electrical signals to extract binary streams from the electrical signals, and provide the binary streams, in the form of data units to the processing circuit 130. In an example, the transmitting circuit may be configured to receive data units, such as management frames, data frames, and the like from for example the processing circuit 130, generate radio frequency (RF) signals to carry the data units, and emit electromagnetic waves in the air via the antenna to transmit wireless signals that carry the data units.

It is noted that in an example, the transceiver circuit 120 is configured to receive and transmit wireless signals according to a suitable Wi-Fi standard, such as IEEE 802.11 standards. In another example, the transceiver circuit 120 is configured to receive and transmit wireless signals according to a suitable mobile communication technology, such as 3G mobile network technology, 4G mobile network technology, 5G mobile network technology, GSM, LTE, and the like. In another example, the transceiver circuit 120 includes a first portion configured to receive and transmit wireless signals according to a suitable Wi-Fi standard, and a second portion configured to receive and transmit wireless signals according to a suitable mobile communication technology.

In an embodiment, the transceiver circuit 120 is configured to support dual downlink paths. In an example, the transceiver circuit 120 includes two receiving circuits configured to receive wireless signals that carry data units from, for example two eNBs in a LTE network simultaneously. In another example, the transceiver circuit 120 includes a first receiving circuit configured to receive wireless signals that carry data units from for example an eNB in an LTE network, and a second receiving circuit configured to receive wireless signals that carry data units from for example an WLAN device in WLAN 106. The first receiving circuit and the second receiving circuit can operate simultaneously to receive wireless signals that carry the data units.

The processing circuit 130 may be configured to perform various processing in baseband. The processing circuit 130 can be implemented using any suitable technology. In an embodiment, the processing circuit 130 is implemented using pure circuits. In another embodiment, the processing circuit 130 is implemented using one or more processors (not shown) and memory circuit (not shown). The memory circuit may be configured to store data and software instructions. The one or more processors may be configured to execute software instructions to perform various operations.

According to an aspect of the disclosure, the processing circuit 130 may be configured to process received data units according to a protocol stack 140 that has multiple protocol layers. In an example, an upper protocol layer may require in-sequence delivery from a lower protocol layer. One of the protocol layers, such as an L(N) protocol layer 150 in the FIG. 1 example, may be configured to reorder the data units according to the sequence numbers.

In an example, the network 105 sends a plurality of data units with respective sequence numbers to the electronic device 110 according to suitable wireless communication protocols. In an example, the sequence numbers are in an increasing order. In an embodiment, a WLAN device 107 in the WLAN 106 forms the plurality of data units with respective sequence numbers, such as layer 2 sequence numbers, and sends the plurality of data units to the electronic device 110. In another embodiment, one or more nodes in the mobile service provider network 101 form the plurality of data units with respective sequence numbers, such as sequence numbers in a packet data convergence protocol (PDCP) layer, and send the plurality of data units to the electronic device 110.

It is noted that at different protocol layers, data units can be referred to using other suitable terms. For example, a data unit is referred to as a frame in a data link layer of a seven-layer open systems interconnection model (OSI model). In another example, each of data units can be a service data unit (SDU), a media access control (MAC) SDU (MSDU), an aggregated MSDU (A-MSDU), a MAC protocol data unit (MPDU), or an aggregated MPDU (A-MPDU). In an embodiment, a data unit received by the L(N) protocol layer 150 from a lower protocol layer are called MPDU (or A-MPDU) while the data unit output of the L(N) protocol layer 150 to the upper L(N+1) protocol layer 160 is referred to by MSDU (or A-MSDU).

According to an aspect of the disclosure, due to various reasons, such as weak connectivity, data unit loss and re-transmission, handover and re-establishment, dual paths, and the like, the electronic device 110 can receive the plurality of the data units out of order of the sequence number. In the FIG. 1 example, five data units with sequence numbers S1-S5 are sent from the network 105 to the electronic device 110. In an example, S1 is a positive integer, S2 is larger than S1 by one, S3 is larger than S2 by one, S4 is larger than S3 by one, and S5 is larger than S4 by one. Initially, the data units are transmitted following the sequence numbers S1-S2-S3-S4-S5. However, the data unit having sequence number S1 may be lost in the initial transmission, and may be referred to as a missing data unit. The missing data unit may be re-transmitted with the original sequence number by the network 105, thus, the electronic device 110 may receive the data units in the order S2-S3-S4-S5-S1.

The processing circuit 130 may receive the data units from the transceiver 120, and process the data units according to the protocol stack 140. In the FIG. 1 example, the L(N) protocol layer 150 is configured to reorder the received data units according to the sequence numbers, and is further configured to advance data units that are independent of one or more missing data units out of order of the sequence numbers for a next process.

In an example, when the L(N) protocol layer 150 receives a specific data unit, the L(N) protocol layer 150 may determine whether the specific data unit is in-sequence according to the sequence number. When the specific data unit is in-sequence according to the sequence number, the specific data unit may be delivered for the next process, for example to the L(N+1) protocol layer 160. When the specific data unit is not in-sequence according to the sequence number, the L(N) protocol layer 150 may determine whether the specific data unit is independent of the one or more missing data units that have sequence numbers prior to the specific data unit. When the specific data unit is independent of the one or more missing data units, the specific data unit may be delivered for the next process, for example to the L(N+1) protocol layer 160.

Specifically, in the FIG. 1 example, the data units with S3, S4 and S5 are independent of the missing data unit with S1, and the data unit with S2 is not independent of the missing data unit with S1. When the L(N) protocol layer 150 receives the data unit with S2, the data unit with S2 is buffered, for example in a reorder buffer 170. The L(N) protocol layer 150 may detect that a data unit with S1 that is prior to S2 has not been received, thus the data unit with S1 is a missing data unit. Further, when the L(N) protocol layer 150 cannot determine that the data unit with S2 is independent of the missing data unit, the data unit with S2 may be buffered to wait for a reception of a data unit with S1.

When the L(N) protocol layer 150 receives the data unit with S3 and determines that the data unit with S3 is independent of the missing data unit with S1, thus the L(N) protocol layer 150 may process and deliver the data unit with S3 to the L(N+1) layer 160 without waiting for the reception of the data unit with S1. The L(N) protocol layer 150 can receive and process the data units with S4 and S5 similarly. Further, when the L(N) protocol layer 150 receives the data unit with S1, the L(N) protocol layer 150 can process the data unit with S1 and the data unit with S2, and deliver the data units with S1 and S2 to the upper L(N+1) layer 160. Thus, the L(N) protocol layer 150 may deliver the data units to the L(N+1) protocol layer 160 in the order of S3-S4-S5-S1-S2.

In a related example, data units are delivered to the next process in the order of the sequence numbers, thus the data units with the sequence numbers S3, S4, and S5 are buffered and wait for the data unit with S1 to be received. Comparing to the related example, the electronic device 110 can process data units, such as the data units with the sequence numbers S3, S4 and S5, with reduced delay.

According to an aspect of the disclosure, the L(N) protocol layer 150 can use any suitable technique to determine whether a data unit is independent of one or more missing data units. In an example, the L(N) protocol layer 150 determines whether the data unit belongs to a protocol that uses individual data unit for messaging, thus the data unit is an independent data unit that is independent of other data units. The protocol that uses individual data unit for messaging can be address resolution protocol (ARP), Internet control message protocol (ICMP), domain name system (DNS) protocol and the like.

In another example, the L(N) protocol layer 150 determines whether the body of the data unit belongs to a higher level protocol, such as a transmission control protocol (TCP), user datagram protocol (UDP), dynamic host configuration protocol (DHCP) and the like that uses a higher level reordering technique. When the body of the data unit belongs to a higher level protocol that uses the higher level reordering technique, the L(N) protocol layer 150 determines that the data unit is independent of the one or more missing data units. In an example, the TCP can reorder based on session sequence numbers. The additional session sequence numbers can be used to control the in-sequence delivery by session. For example, the L(N) protocol layer 150 extracts higher level information from body of the data unit, such as session sequence numbers, and uses the higher level information to assist reordering. In another example, data units of UDP can include position information in data units at an application level to assist in-sequence delivery. In another example, data units of DHCP can be reordered based on a combination of multiple fields of the DHCP protocol.

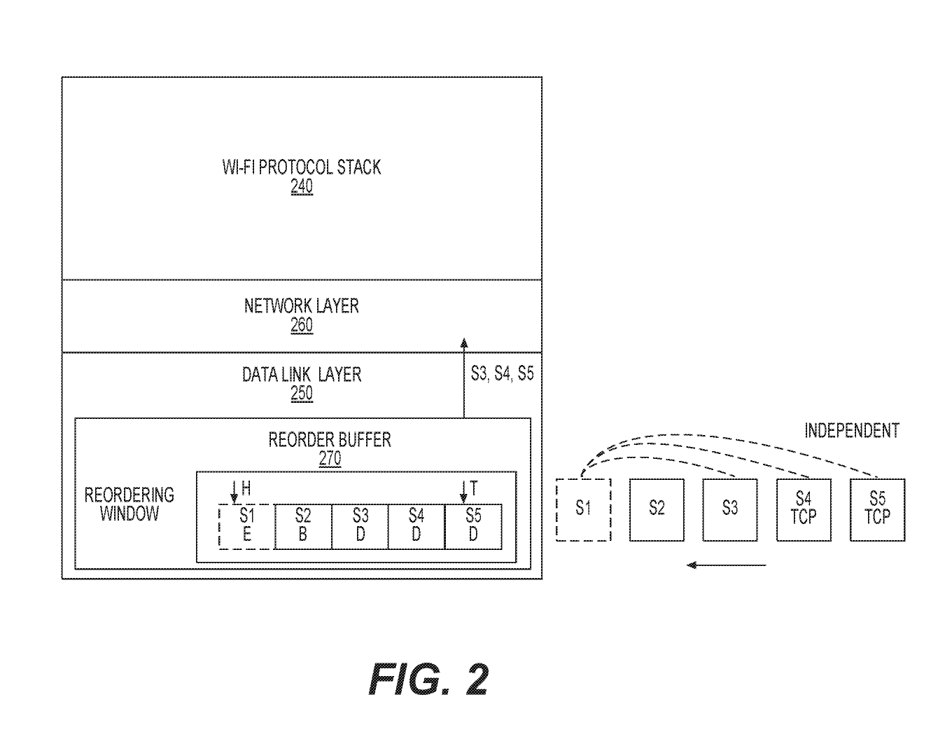

FIG. 2 shows a diagram of data unit reordering and delivery in a Wi-Fi protocol stack 240 according to an embodiment of the disclosure. In an example, the Wi-Fi protocol stack 240 is used in the electronic device 110 in the place of the protocol stack 140.

According to an aspect of the disclosure, the Wi-Fi protocol stack 240 may include a plurality of protocol layers, such as a data link layer (layer 2 in open systems interconnection model) 250, a network layer (layer 3 in open systems interconnection model) 260, and the like. It is noted that the Wi-Fi protocol stack 240 may include other suitable layers that are not shown in FIG. 2, such as a transport layer (layer 4 in open systems interconnection model), and the like.

The Wi-Fi protocol stack 240 may process a received data unit from a lower protocol layer, such as the data link layer 250, to the upper protocol layers. The data link layer 250 may be configured to provide layer 2 services, such as regulation of access to wireless media, flow control, error control and the like. In an embodiment, each of the data units can be an SDU, an MSDU, an A-MSDU, an MPDU, or an A-MPDU. In an embodiment, a data unit received by the data link layer 250 from a physical layer is called MPDU (or A-MPDU) while the data unit output of the data link layer 250 to the network layer 260 is referred to by MSDU (or A-MSDU).

According to an aspect of the disclosure, one of the operations performed in the data link layer 250 is a reorder operation that reorders the data units according to layer 2 sequence numbers. According to an aspect of the disclosure, the data link layer 250 is configured to advance a specific data unit out of order of the sequence numbers to a next process (e.g., a next operation in the data link layer 250, or a next operation in the network layer 260) when the specific data unit is independent of one or more missing data units.

Specifically, in an embodiment, a WLAN device (e.g., an access point device) may form data units with layer 2 sequence numbers, and transmit the data units with the layer 2 sequence numbers to the electronic device 110. In an example, the WLAN device forms five data units with sequence numbers S1-S5 and sends the data units to the electronic device 110. In an example, S1 is a positive integer, S2 is larger than S1 by one, S3 is larger than S2 by one, S4 is larger than S3 by one, and S5 is larger than S4 by one. Initially, the data units are transmitted following the sequence numbers S1-S2-S3-S4-S5. However, the data unit with S1 is lost in the initial transmission, and is referred to as a missing data unit. Thus, the electronic device 110 receives the data units in the order of S2-S3-S4-S5. In an example, when the data unit loss is detected, the WLAN device re-transmits the data unit with the original layer 2 sequence number S1.

In the embodiment, the data link layer 250 may be configured to reorder the data units according to the layer 2 sequence numbers. In an example, the data link layer 250 uses a reorder buffer 270 having a reordering window to reorder the data units. For example, the reorder buffer 270 is configured to buffer data units that are out of order, and the reordering window is configured to track sequence numbers of the buffered data units. In an example, the reordering window includes slots sequentially corresponding to the sequence numbers. The reordering window may have a header (H) that points to the slot with the smallest sequence number in the reordering window and a tail (T) that points to the slot with the largest sequence number in the reordering window. The slot pointed by the header (header slot) may correspond to a next expected layer 2 sequence number. The slot pointed by the tail (tail slot) may correspond to the largest layer 2 sequence number from the received data units at the data link layer 250.

In an example, the slots in the reordering window have three states, such as an empty state (E), a buffered state (B), a delivered state (D), and the three states are used to keep track of data unit reordering process. When a slot has an empty state, a data unit with a sequence number corresponding to the slot has not been received, and the data unit is referred to as a missing data unit. When a slot has a buffered state, a data unit with a sequence number corresponding to the slot is received and buffered in the reorder buffer. When a slot has a delivered state, a data unit with a sequence number corresponding to the slot is received and delivered to the next process, such as the network layer 260.

In an example, when the data link layer 250 receives a data unit, the data unit is buffered in the reorder buffer 270, and the reordering window is updated accordingly. In an example, when the data unit has a sequence number that is larger than the header slot, but smaller than the tail slot, the slot in the reordering window that corresponds to the sequence number is updated with the buffered state (B).

When the data unit has the sequence number of the header slot, the data unit can be delivered to the next process, and the header slot of the reordering window can be updated for example to the next slot. It is noted that when the new header slot is in the buffered state, a buffered data unit with a sequence number corresponding to the new header slot can be delivered to the network layer, and the header slot can be updated again until the new header slot has an empty state.

When the data unit has a sequence number larger than the tail slot, a new slot correspond to the sequence number is updated to the buffered state (B) and the tail is updated to point to the new slot.

Specifically, in an example, the data units with sequence numbers S3, S4 and S5 are independent of the data unit with S1, and the data unit with the sequence number S2 is not independent of the data unit with S1. In an example, the data unit with S3 belongs to a protocol, such as ARP, ICMP, DNS protocol and the like that uses an individual data unit for messaging. Further in the example, the body of the data units with S4 and S5 belong to TCP that uses for example TCP session sequence numbers to ensure in-sequence delivery.

During operation, in the FIG. 2 example, the header of the reordering window points to the slot corresponding to S1 that is the smallest sequence number to expect. When the data link layer 250 receives the data unit with S2, the data unit with S2 is buffered, for example in the reorder buffer 270. The data link layer 250 may detect that a data unit with S1 that is prior to S2 has not been received, thus the data unit with S1 is a missing data unit. Further, when the data link layer 250 cannot determine that the data unit with S2 is independent of the missing data unit, the data unit with S2 is buffered to wait for a reception of a data unit with S1. Further, the slot corresponding to S2 is updated to the buffered state, and the tail of the reordering window points to the slot corresponding to S2.

When the data link layer 250 receives the data unit with S3, the data link layer 250 may determine that the data unit with S3 belongs to a protocol, such as ARP, ICMP, DNS protocol and the like that uses an individual data unit for messaging, and thus the data unit with S3 is independent of the missing data unit. Then the data link layer 250 may deliver the data unit with S3 to a next process, such as the network layer 260 without waiting for the reception of the missing data unit. Then, the slot corresponding to S3 may be updated to the delivered state, and the tail of the reordering window may point to the slot corresponding to S3.

Similarly, when the data link layer 250 receives the data unit with S4, the data link layer 250 may determines that the body of the data unit with S4 belongs to TCP that uses TCP session sequence numbers to ensure in-sequence delivery, thus the data unit with S4 is independent of the missing data unit. Then, the data link layer 250 may deliver the data unit with S4 to a next process, such as the network layer 260 without waiting for the reception of the missing data unit. Then, the slot corresponding to S4 may be updated to the delivered state, and the tail of the reordering window may point to the slot corresponding to S4.

Similarly, when the data link layer 250 receives the data unit with S5, the data link layer 250 may determine that the body of the data unit with S5 belongs to TCP that uses TCP session sequence numbers to ensure in-sequence delivery, thus the data unit with S5 is independent of the missing data unit. Then, the data link layer 250 may deliver the data unit with the S5 to a next process, such as the network layer 260 without waiting for the reception of the missing data unit. Then, the slot corresponding to S5 may be updated to the delivered state, and the tail of the reordering window may point to the slot corresponding to S5.

In the FIG. 2 example, the data units with the sequence numbers S3, S4, and S5 are delivered to the next process before the reception of the missing data unit, thus the data units with the sequence numbers S3, S4 and S5 are processed with reduced delay.

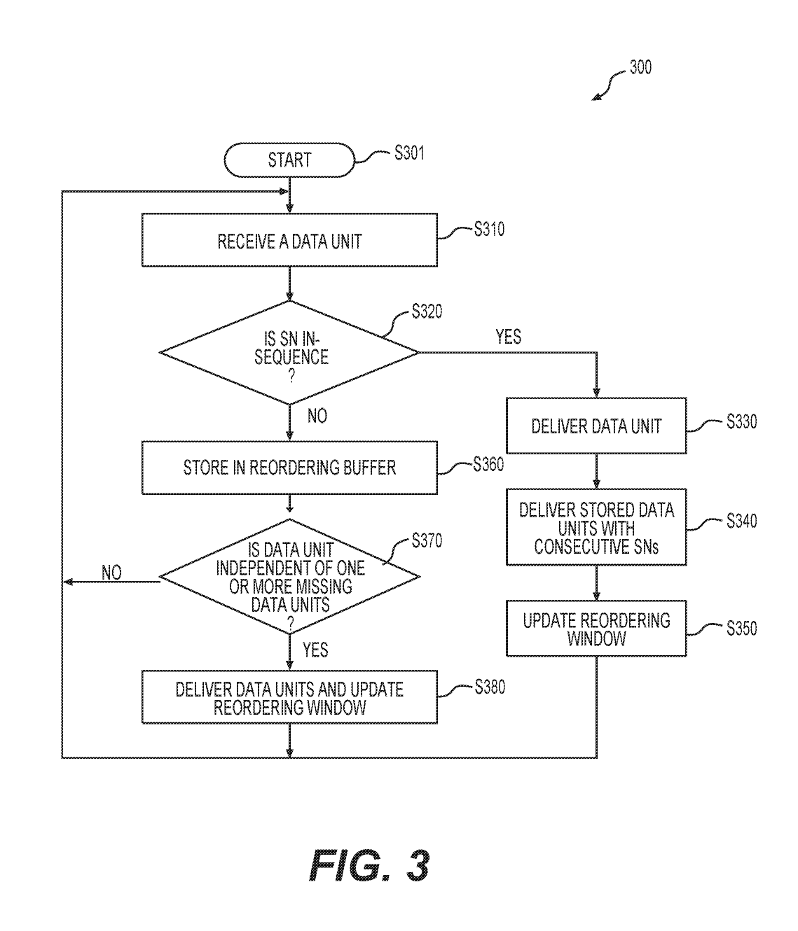

FIG. 3 shows a flow chart outlining a process 300 for data unit reordering and delivery according to an embodiment of the disclosure. In an example, the process 300 is executed in the processing circuit 130, by a protocol layer, such as the data link layer 250 in the Wi-Fi protocol stack 240. The process starts at S301 and proceeds to S310.

At S310, a data unit may be received at the protocol layer. In an example, the transceiver circuit 120 generates electrical signals in response to captured electromagnetic waves by the antenna, process the electrical signals to extract binary streams from the electrical signals, and provide the binary streams, in the form of a data unit to the processing circuit 130. The data link layer 250 then receives the data unit.

At S320, the protocol layer may determine whether the data unit is in sequence. In an example, when the data unit has the sequence number of the header slot for the reordering window, the data unit is in sequence. For example, when the data unit has the sequence number S1, the data unit is in sequence. When the data unit has larger sequence number than the header slot, the data unit is not in sequence. When the data unit is in sequence, the process may proceed to S330; otherwise, the process may proceed to S360.

At S330, the data unit may be delivered to a next process. In an example, the data link layer 250 may deliver the data unit for next processes, and deliver the processed data unit to the network layer 260. In another example, the data link layer 250 may deliver the data unit to the network layer 260. In an example, when the data link layer 250 receives the data unit with the sequence number S1, the data unit is delivered to the next process and the network layer 260.

At S340, buffered data units with consecutive sequence numbers may be delivered to the next process. In an example, when the reordering window has no other missing data unit, the data link layer 250 may deliver the buffered data units in the reordering window to the next process. In the example, when the reordering window has more missing data units, the data link layer 250 may deliver, for example sequentially, the buffered data units with sequence numbers prior to a next missing data unit to next processes. The processed data units can be delivered to the network layer 260. In the FIG. 2 example, the data unit with the sequence number S2 is buffered before the data unit with the sequence number S1 is received. When the data unit with the sequence number S1 is received and delivered to the next process and the network layer 260, the buffered data unit with the sequence number S2 can be delivered to the next process and the network layer 260.

At S350, the reordering window may be updated. In an example, when the reordering window has no missing data unit, the header is updated to point a slot corresponding to a next expected sequence number (e.g., the smallest sequence number that has not been received). In the example, when the reordering window has more missing data units, the header is updated to point to the slot for the next missing data unit.

At S360, the data unit may be stored in a buffer. In the FIG. 2 example, the data unit is stored in the reorder buffer 270, and the reordering window is updated. For example, when the data unit has a sequence number that is larger than the header slot, but smaller than the tail slot, the slot in the reordering window that corresponds to the sequence number is updated with the buffered state (B). When the data unit has a sequence number larger than the tail slot, a new slot corresponding to the sequence number is updated to the buffered state (B) and the tail is updated to point to the new slot.

At S370, the protocol layer may determine whether the data unit is independent of one or more missing data units having sequence numbers that are prior to the data unit. For example, when the data unit belongs to a protocol, such as ARP, ICMP, DNS protocol and the like that uses individual data unit for messaging, the data unit is independent of the one or more missing data units. In another example, when the body of the data units belongs to a protocol, such as TCP, that uses for example high level sequence numbers, such as session sequence numbers, to ensure in-sequence delivery, the data unit is considered independent of the one or more missing data units. When the data unit is independent of the one or more missing data units, the process proceeds to S380, otherwise, the process returns to S310 to receive another data unit.

At S380, the data unit may be delivered to the next process and the reordering window may be updated. In an example, the data link layer 250 delivers the data unit to the next process, and the slot corresponding to the data unit is updated to be delivered. The process returns to S310 to receive another data unit.

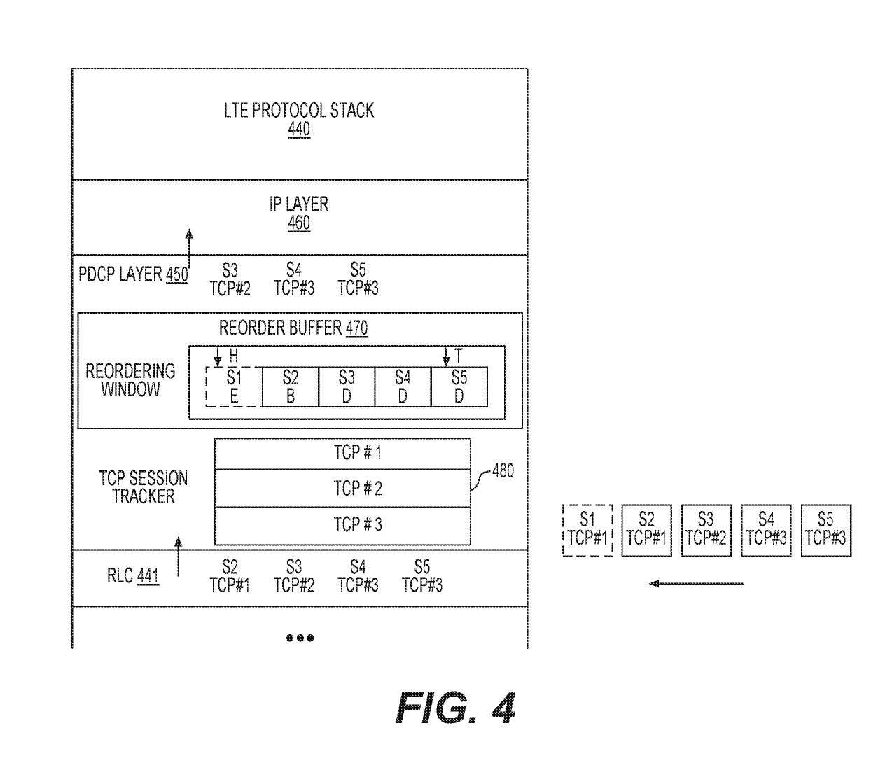

FIG. 4 shows another diagram of data unit reordering and delivery in a LTE protocol stack 440 according to an embodiment of the disclosure. In an example, the LTE protocol stack 440 is used in the electronic device 110 in the place of the protocol stack 140. Although LTE is taken as an example in FIG. 4, this invention applies to UMTS or any other communications technology as well.

According to an aspect of the disclosure, the LTE protocol stack 440 may include a plurality of protocol layers, such as a radio link control (RLC) layer 441, a PDCP layer 450, an Internet protocol (IP) layer 460 (e.g., equivalent to layer 3 in open systems interconnection model), and the like. It is noted that the LTE protocol stack 440 may include other suitable layers that are not shown in FIG. 4, such as an MAC layer under the RLC layer 441, and the like.

The LTE protocol stack 440 may process a received data unit from a lower protocol layer to the upper protocol layers. The PDCP layer 450 may be configured to perform header compression/decompression of IP data, transfer of data (user plane or control plane), maintenance of PDCP sequence numbers, ciphering/deciphering of user plane data and control plane data, integrity protection and integrity verification of control plane data. In an embodiment, each of the data units can be an SDU, an MSDU, an A-MSDU, an MPDU, or an A-MPDU. In an embodiment, a data unit received by the PDCP layer 450 from RLC 441 is called MPDU (or A-MPDU) while the data unit output of PDCP layer 450 to the IP 460 is referred to by MSDU (or A-MSDU).

Specifically, in the FIG. 4 example, the PDCP layer 450 is configured to receive data units, perform suitable operations on the data units, and provide processed data units to a next process, such as the IP layer 460 for further processing. According to an aspect of the disclosure, one of the operations performed in the PDCP layer 450 is a reorder operation that reorders the data units according to PDCP sequence numbers. According to an aspect of the disclosure, the PDCP layer 450 is configured to advance a specific data unit out of order of the PDCP sequence number to a next process, such as the IP layer 460, when the specific data unit is independent of one or more missing data units.

Specifically, in an embodiment, one or more nodes in the mobile service provider network 101 form data units with PDCP sequence numbers, and transmit the data units with the PDCP sequence numbers to the electronic device 110. In an example, five data units with PDCP sequence numbers S1-S5 are formed and sent to the electronic device 110. In an example, S1 is a positive integer, S2 is larger than S1 by one, S3 is larger than S2 by one, S4 is larger than S3 by one, and S5 is larger than S4 by one. Initially, the data units are transmitted following the PDCP sequence numbers S1-S2-S3-S4-S5. However, the data unit having sequence number S1 is lost in the initial transmission, and is referred to as a missing data unit. Thus, the electronic device 110 receives the data units in the order S2-S3-S4-S5. In an example, when the data unit loss is detected, the mobile service provider network 101 re-transmits the data unit with the original PDCP sequence number S1.

In the embodiment, the PDCP layer 450 is configured to reorder the data units according to the PDCP sequence numbers. In an example, the PDCP layer 450 uses a reorder buffer 470 having a reordering window to reorder data units. For example, the reorder buffer 470 is configured to buffer data units that are out of order, and the reordering window is configured to track sequence numbers of the buffered data units. In an example, the reordering window includes slots corresponding to PDCP sequence numbers. The reordering window has a header (H) that points to the slot with the smallest sequence number in the reordering window and a tail (T) that points to the slot with the largest sequence number in the reordering window. The slot pointed by the header (header slot) corresponds to a next expected PDCP sequence numbers. The slot pointed by the tail (tail slot) corresponds to the largest PDCP sequence number from the received data units.

The slots in the reordering window may have three states, such as an empty state (E), a buffered state (B), a delivered state (D), and the three states may be used to keep track of data unit reordering process. When a slot has an empty state, a data unit with a sequence number corresponding to the slot has not been received, and the data unit can be referred to as a missing data unit. When a slot has a buffered state, a data unit with a sequence number corresponding to the slot is received and buffered in the reorder buffer. When a slot has a delivered state, a data unit with a sequence number corresponding to the slot is received and delivered to the next process, such as the IP layer 460.

In an example, when the PDCP layer 450 receives a data unit, the data unit is buffered in the reorder buffer 470, and the reordering window is updated accordingly. In an example, when the data unit has a PDCP sequence number that is larger than the header slot, but smaller than the tail slot, the slot in the reordering window that corresponds to the sequence number is updated with the buffered state (B).

When the data unit has the sequence number of the header slot, the data unit is delivered to the next process, and the header slot of the reordering window is updated for example to the next slot. It is noted that, in an example, when the new header slot is in the buffered state, a buffered data unit with a sequence number corresponding to the new header slot is delivered to the upper layer, and the header slot is updated again until the new header slot has an empty state.

When the data unit has a PDCP sequence number larger than the tail slot, in an example, a new slot corresponding to the PDCP sequence number is updated to the buffered state (B) and the tail is updated to point to the new slot.

Specifically, in an example, the data units with PDCP sequence numbers S3, S4 and S5 are independent of the data unit with S1, and the data unit with S2 is not independent of the data unit with S1. In an example, the bodies of the data units with S1-S5 belong to TCP that uses for example TCP session sequence numbers to ensure in-sequence delivery. For example, the bodies of the data units with S1 and S2 belong to a first TCP session (TCP#1), the body of the data unit with S3 belongs to a second TCP session (TCP#2), and the bodies of the data units with S4 and S5 belong to a third TCP session (TCP#3). Thus, data units in different TCP sessions are independent of each other.

In an embodiment, the PDCP layer 450 extracts higher level protocol information, and uses the higher level protocol information for reordering. In the FIG. 4 example, the PDCP layer 450 includes TCP session tracker 480 configured to track TCP sessions TCP#1, TCP#2 and TCP#3. In an example, the TCP session tracker 480 tracks the next expected TCP session sequence numbers respectively for the TCP sessions TCP#1, TCP#2 and TCP#3.

During operation, in the FIG. 4 example, the header of the reordering window points to the slot corresponding to S1 to expect the data unit with the PDCP sequence number S1. When the PDCP layer 450 receives the data unit with S2, the data unit with the sequence number S2 is buffered. The PDCP layer 450 detects that a data unit with S1 that is prior to S2 has not been received, thus the data unit with S1 is a missing data unit. Further, the PDCP 450 may determine that the data unit with S2 is not independent of the one or more missing data units. For example, the PDCP 450 may extract the TCP session (e.g., TCP#1), and TCP session sequence number from data unit with S2. The TCP session sequence number does not match the next expected TCP session sequence number in the TCP session tracker 480 for TCP#1, thus the data unit with S2 is not independent of the missing data unit. Thus, the data unit is buffered in the reorder buffer 470 to wait for a reception of the missing data unit. Then, the slot corresponding to S2 is updated to the buffered state, and the tail of the reordering window points to the slot corresponding to S2.

When the PDCP layer 450 receives the data unit with S3, the PDCP layer 450 may determine that the data unit with the PDCP sequence number S3 is independent of the missing data unit. For example, the PDCP layer 450 may extract the TCP session (e.g., TCP#2), and TCP session sequence number from the data unit with S3. In the example, the TCP session sequence number matches the next expected TCP session sequence number in the TCP session tracker 480 for TCP#2, thus the data unit with S3 is independent of the missing data unit. Then, the PDCP layer 450 may deliver the data unit with S3 to a next process, such as the IP layer 460 without waiting for the reception of the missing data unit. Then, the slot corresponding to S3 is updated to the delivered state, and the tail of the reordering window points to the slot corresponding to S3. The TCP session tracker 480 may also update the next expected TCP session sequence number for TCP#2.

Similarly, when the PDCP layer 450 receives the data unit with S4, the PDCP layer 450 may determine that the data unit with S4 is independent of the missing data unit. For example, the PDCP layer 450 may extract the TCP session (e.g., TCP#3), and TCP session sequence number from the data unit with S4. In the example, the TCP session sequence number matches the next expected TCP session sequence number in the TCP session tracker 480 for TCP#3, thus the data unit with S4 is independent of the missing data unit. Then, the PDCP layer 450 may deliver the data unit with the sequence number S4 to a next process, such as the IP layer 460 without waiting for the reception of the missing data unit. Then, the slot corresponding to S4 is updated to the delivered state, and the tail of the reordering window points to the slot corresponding to S4. The TCP session tracker 480 may also update the next expected TCP session sequence number for TCP#3.

Similarly, when the PDCP layer 450 receives the data unit with S5, the PDCP layer 450 may determine that the data unit with S5 is independent of the missing data unit. For example, the PDCP layer 450 may extract the TCP session (e.g., TCP#3), and TCP session sequence number from the data unit with S5. In the example, the TCP session sequence number matches the next expected TCP sequence number in the TCP session tracker 480 for TCP#3, thus the data unit with S5 is independent of the missing data unit. Then, the PDCP layer 450 may deliver the data unit with S5 to a next process, such as the IP layer 460 without waiting for the reception of the missing data unit. Then, the slot corresponding to S5 is updated to the delivered state, and the tail of the reordering window points to the slot corresponding to S5. The TCP session tracker 480 also updates the next expected TCP session sequence number for TCP#3.

In the FIG. 4 example, the data units with the PDCP sequence numbers S3, S4, and S5 are delivered to the next process before the reception of the missing data unit, thus the data units with S3, S4 and S5 are processed with reduced delay.

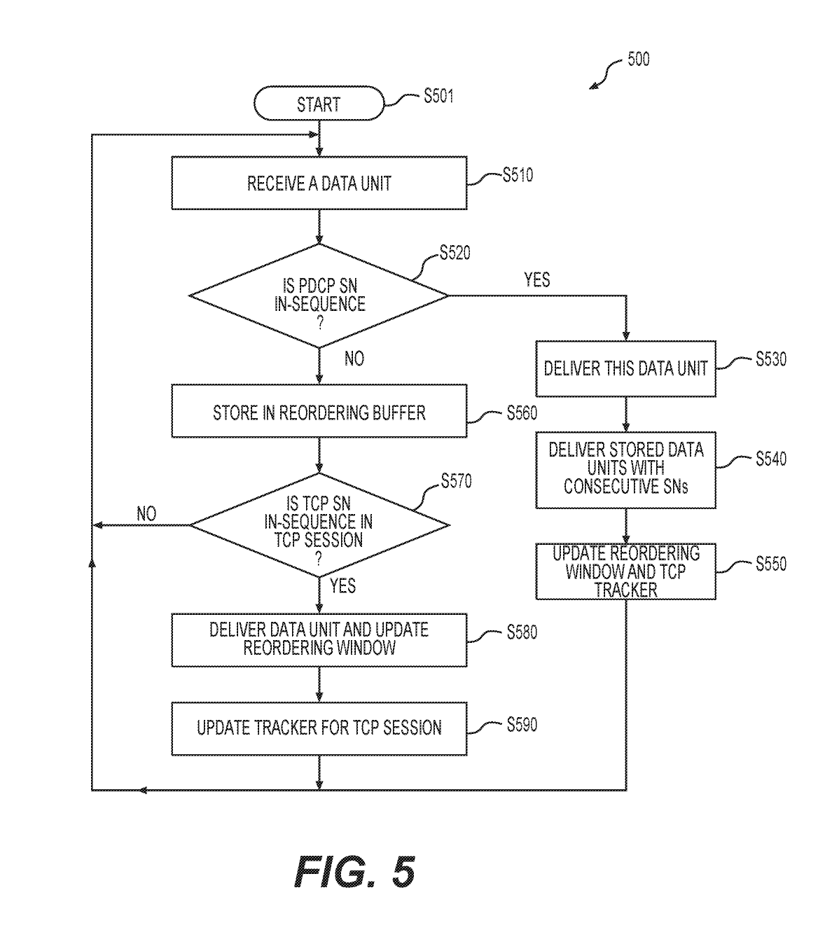

FIG. 5 shows another flow chart outlining a process 500 for data unit reordering and delivery according to an embodiment of the disclosure. In an example, the process 500 is executed in the processing circuit 130, by a protocol layer, such as the PDCP layer 450 in the LTE protocol stack 440. The process starts at S501 and proceeds to S510.

At S510, a data unit is received at the protocol layer. In an example, the transceiver circuit 120 generates electrical signals in response to captured electromagnetic waves by the antenna, process the electrical signals to extract binary streams from the electrical signals, and provide the binary streams, in the form of a data unit to the processing circuit 130. The data unit is processed by the MAC layer and the RLC layer 441 in an example. The RLC layer 441 provides the processed data unit to the PDCP layer 450. The PDCP layer 450 then receives the data unit.

At S520, the protocol layer may determine whether the data unit is in sequence. In an example, when the data unit has the PDCP sequence number of the header slot of the reordering window, the data unit is in sequence. When the data unit has larger PDCP sequence number than the header slot, the data unit is not in sequence. When the data unit is in sequence, the process proceeds to S530; otherwise, the process proceeds to S560.

At S530, the data unit is delivered to a next process. In an example, the PDCP layer 450 delivers the processed data unit to the IP layer 460. In the FIG. 4 example, when the PDCP layer 450 receives the data unit with the PDCP sequence number S1, the data unit is in sequence and is delivered to the next process and the IP layer 460.

At S540, buffered data units with consecutive PDCP sequence numbers are delivered to the next process. In an example, when the reordering window has no other missing data unit, the PDCP layer 450 delivers the buffered data units in the reordering window to the next process. In the example, when the reordering window has more missing data units, the PDCP layer 450 delivers, for example sequentially, the buffered data units with sequence numbers prior to a next missing data unit to the next process. In the FIG. 4 example, the data unit with the PDCP sequence number S2 is buffered before the data unit with the PDCP sequence number S1 is received. When the data unit with the sequence number S1 is received and delivered to the next process and the IP layer 460, the buffered data unit with the PDCP sequence number S2 can be delivered to the next process and the IP layer 460.

At S550, the reordering window is updated. In an example, when the reordering window has no missing data units, the header is updated to point a slot corresponding to a next expected PDCP sequence number. In the example, when the reordering window has more missing data units, the header is updated to point to the slot for the next missing data unit. In an embodiment, the TCP session track 480 is updated based on the TCP information in the delivered data units.

At S560, the data unit is stored in a buffer. In the FIG. 4 example, the data unit is stored in the reorder buffer 470, and the reordering window is updated. For example, when the data unit has a PDCP sequence number that is larger than the header slot, but smaller than the tail slot, the slot in the reordering window that corresponds to the PDCP sequence number is updated with the buffered state (B). When the data unit has a PDCP sequence number larger than the tail slot, a new slot correspond to the PDCP sequence number is updated to the buffered state (B) and the tail is updated to point to the new slot.

At S570, the protocol layer may determine whether the data unit is independent of one or more missing data units having PDCP sequence numbers that are prior to the data unit. For example, the PDCP layer 450 extracts the TCP session, and TCP session sequence number from data unit. When the TCP session sequence number matches the next expected TCP session sequence number in the TCP session tracker 480 for the TCP session, thus the data unit is independent of the one or more missing data units. When the data unit is independent of the one or more missing data units, the process proceeds to S580; otherwise, the process returns to S510 to receive another data unit.

At S580, the data unit is delivered to the next process and the reordering window is updated. In an example, the PDCP 450 delivers the data unit to next process, for example the IP layer 460, and the slot corresponding to the data unit is updated to be the delivered state.

At S590, the TCP session track 480 is updated accordingly. For example, the next expected TCP sequence number for the TCP session is updated. The process returns to S510 to receive another data unit.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for communication, comprising:
receiving, by a terminal device, a stream of data units from a wireless network, the data units having respective sequence numbers;
reordering, at a protocol layer in a protocol stack, the data units for a next process according to the sequence numbers;
determining a dependency relationship of a data unit to one or more missing data units that have sequence numbers prior to the data unit; and
advancing, out of order of the sequence numbers, the data unit to a next process when the data unit is independent of the one or more missing data units.

2. The method of claim 1, wherein reordering, at the protocol layer in the protocol stack, the data units for the next process according to the sequence numbers further comprises:
reordering, at a packet data convergence protocol (PDCP) layer in the protocol stack, the data units for the next process according to PDCP sequence numbers.

3. The method of claim 2, wherein determining the dependency relationship of the data unit to the one or more missing data units that have sequence numbers prior to the data unit further comprises:
extracting, at the PDCP layer, a transmission control protocol (TCP) session sequence number for a TCP session in the data unit; and
determining whether the TCP session sequence number is in sequence in the TCP session.

4. The method of claim 3, further comprising:
advancing, out of order of the PDCP sequence numbers, the data unit to the next process when the TCP session sequence number is in sequence in the TCP session.

5. The method of claim 1, wherein reordering, at the protocol layer in the protocol stack, the data units for the next process according to the sequence numbers further comprises:
reordering, at a data link layer in a Wi-Fi protocol stack, the data units for the next process according to the sequence numbers.

6. The method of claim 5, wherein determining the dependency relationship of the data unit to the one or more missing data units that have sequence numbers prior to the data unit further comprises:
determining that the data unit is independent of the one or more missing data units when the data unit belongs to at least one of an address resolution protocol (ARP), an internet control message protocol (ICMP), a domain name system (DNS) protocol.

7. The method of claim 5, wherein determining the dependency relationship of the data unit to the one or more missing data units that have sequence numbers prior to the data unit further comprises:
determining that the data unit is independent of the one or more missing data units when the data unit belongs to a packet flow that uses a higher level protocol to control an in-sequence delivery.

8. The method of claim 7, wherein determining that the data unit is independent of the one or more missing data units when the data unit belongs to the packet flow that uses the higher level protocol to control the in-sequence delivery further comprises:
determining that the data unit is independent of the one or more missing data units when body of the data unit belongs to one of a transmission control protocol (TCP), user datagram protocol (UDP), and dynamic host configuration protocol (DHCP) that use additional higher level information to control the in-sequence delivery.

9. An apparatus, comprising:
a receiving circuit configured to receive a wireless signal from a wireless network and generate a stream of data units in response to the wireless signal, the data units having respective sequence numbers; and
a processing circuit configured to:
reorder, at a protocol layer in a protocol stack, the data units for a next process according to the sequence numbers;
determine, a dependency relationship of a data unit to one or more missing data units that have sequence numbers prior to the data unit; and
advance, out of order of the sequence numbers, the data unit to the next process when the data unit is independent of the one or more missing data units.

10. The apparatus of claim 9, wherein the processing circuit is further configured to:
reorder, at a packet data convergence protocol (PDCP) layer in the protocol stack, the data units for the next process according to the sequence numbers.

11. The apparatus of claim 10, wherein the sequence numbers are PDCP sequence numbers in the PDCP layer, and the processing circuit is configured to:
extract, at the PDCP layer, a transmission control protocol (TCP) sequence number for a TCP session in the data unit; and
determine whether the TCP sequence number is in sequence in the TCP session.

12. The apparatus of claim 11, wherein the processing circuit is configured to:
advance, out of order of the PDCP sequence numbers, the data unit to the next process when the TCP sequence number is in sequence in the TCP session.

13. The apparatus of claim 9, wherein the processing circuit is configured to:
determine, at a data link layer in a Wi-Fi protocol stack, the dependency relationship of the data unit to the one or more missing data units that have the sequence numbers prior to the data unit.

14. The apparatus of claim 13, wherein the processing circuit is configured to:
determine that the data unit is independent of the one or more missing data units when the data unit belongs to at least one of an address resolution protocol (ARP), an internet control message protocol (ICMP), a domain name system (DNS) protocol.

15. The apparatus of claim 13, wherein the processing circuit is configured to:
determine that the data unit is independent of the one or more missing data units when the data unit belongs to a packet flow that uses a higher level protocol to control an in-sequence delivery.

16. The apparatus of claim 15, wherein the processing circuit is configured to:
determine that the data unit is independent of the one or more missing data units when body of the data unit belongs to one of a transmission control protocol (TCP), user datagram protocol (UDP), and dynamic host configuration protocol (DHCP) that use additional higher level information to control the in-sequence delivery.

17. An apparatus, comprising:
a receiving circuit configured to receive a wireless signal from a wireless network and generate a stream of data units in response to the wireless signal, the data units having respective sequence numbers,
a memory configured to store program instructions of a protocol stack for data unit processing; and
one or more processors configured to execute the program instructions to:
reorder, at a protocol layer in the protocol stack, the data units for a next process according to the sequence numbers;
determine, a dependency relationship of a data unit to one or more missing data units that have sequence numbers prior to the data unit; and
advance, out of order of the sequence numbers, the data unit to a next process when the data unit is independent of the one or more missing data units.

18. The apparatus of claim 17, wherein the one or more processors are configured to execute the program instructions to:
reorder, at a packet data convergence protocol (PDCP) layer in the protocol stack, the data units for the next process according to the sequence numbers that are PDCP sequence numbers;
extract, a transmission control protocol (TCP) sequence number for a TCP session in the data unit;
determine whether the TCP sequence number is in sequence in the TCP session;
advance, out of order of the PDCP sequence numbers, the data unit to the next process when the TCP sequence number is in sequence in the TCP session.

19. The apparatus of claim 17, wherein the protocol stack is a Wi-Fi protocol stack and the one or more processors are configured to execute the program instructions to:
reorder, at a data link layer in the Wi-Fi protocol stack, the data units for the next process according to the sequence numbers;
determine that the data unit is independent of the one or more missing data units when the data unit belongs to at least one of an address resolution protocol (ARP), an internet control message protocol (ICMP), a domain name system (DNS) protocol; and
advance, out of order of the sequence numbers, the data unit to the next process when the data unit is independent of the one or more missing data units.

20. The apparatus of claim 17, wherein the protocol stack is a Wi-Fi protocol stack and the one or more processors are configured to execute the program instructions to:
reorder, at a data link layer in the Wi-Fi protocol stack, the data units for the next process according to the sequence numbers;
determine that the data unit is independent of the one or more missing data units when body of the data unit belongs to one of a transmission control protocol (TCP), user datagram protocol (UDP), and dynamic host configuration protocol (DHCP) that use additional higher level information to control the in-sequence delivery; and
advance, out of order of the sequence numbers, the data unit to the next process when the data unit is independent of the one or more missing data units.
